(19) United States
(12) Patent Application Publication
(10) Pub. No.: US 2010/0276364 A1
(43) Pub. Date: Nov. 4, 2010

(54) WASTEWATER TREATMENT SYSTEM AND METHOD

(76) Inventors: MICHAEL DALE FLETCHER, Grove, OK (US); WILLIAM WADE CLARKSON, Tulsa, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/771,762

(22) Filed: Apr. 30, 2010

Related U.S. Application Data
(60) Provisional application No. 61/174,783, filed on May 1, 2009.

(51) Int. Cl. C02F 3/02

(52) U.S. Cl. 210/617; 210/150; 210/151

(57) ABSTRACT

An aerobic treatment unit is disclosed. The unit provides a tank with an influent end and an effluent end. A growth media is between the influent and effluent ends. An aeration chamber with a diffuser plate is disposed near the influent end. At least one pump moves surface liquids from the near the effluent end to the aeration chamber, where the fluids are aerated by the diffuser plate, back to an area in the tank near the influent end.

### CROSS REFERENCE TO RELATED APPLICATIONS

This application claims the priority of U.S. Provisional Patent Application No. 61/174,783 entitled “SMALL SUBSURFACE FLOW CONSTRUCTED WETLANDS AND INTERMEDIATE TREATMENT IN SEPTIC SYSTEMS,” filed May 1, 2009, the contents of which are hereby incorporated by reference.

### FIELD OF THE INVENTION

This disclosure relates to septic and sewer systems in general and, more specifically, to post septic discharge treatment.

### BACKGROUND OF THE INVENTION

Septic systems are a common means of sewage treatment, but during rainfall events non-point discharge of organics, nutrients and pathogens from these systems is possible to ground and/or surface waters. An intermediate treatment step between the septic tank and drain-field that decreases organics, nutrients and pathogens would decrease pollutant loading onto the drain-field and thus decrease non-point source discharge from the system. Small, commercial aerobic treatment units (ATUs) and filter systems can serve as intermediate treatment, but may be avoided by the homeowner due to their expense.

What is needed is a system and method that addresses the above, and related, concerns.

### SUMMARY OF THE INVENTION

The invention of the present disclosure, in one aspect thereof, comprises an aerobic treatment unit having a tank with an influent end and an effluent end. A growth media is between the influent and effluent ends. An aeration chamber with a diffuser plate is disposed near the influent end. At least one pump moves surface liquids from the near the effluent end to the aeration chamber, where the fluids are aerated by the diffuser plate, back to an area in the tank near the influent end. A settling chamber may be provided near the effluent end where solids collect on a bottom thereof and where the at least one pump is situated near a top thereof.

The influent end may receive influent from a septic tank. A pump may be provided for removing solid materials from the near the effluent end. The surface liquid pump may provide for substantially complete turnover of liquids within the tank about every 19 minutes and may provides sufficient fluid aeration on the diffuser plate to maintain aerobic bacterial activity within the tank.

### BRIEF DESCRIPTION OF THE DRAWINGS

FIG. 1 is a perspective view of a septic system.

FIG. 2 is a side cutaway view of one embodiment of drip aeration system according to aspects of the present disclosure.

FIG. 3 is a side cutaway view of another embodiment of a drip aeration system according to aspects of the present disclosure.

### DETAILED DESCRIPTION OF THE PREFERRED EMBODIMENTS

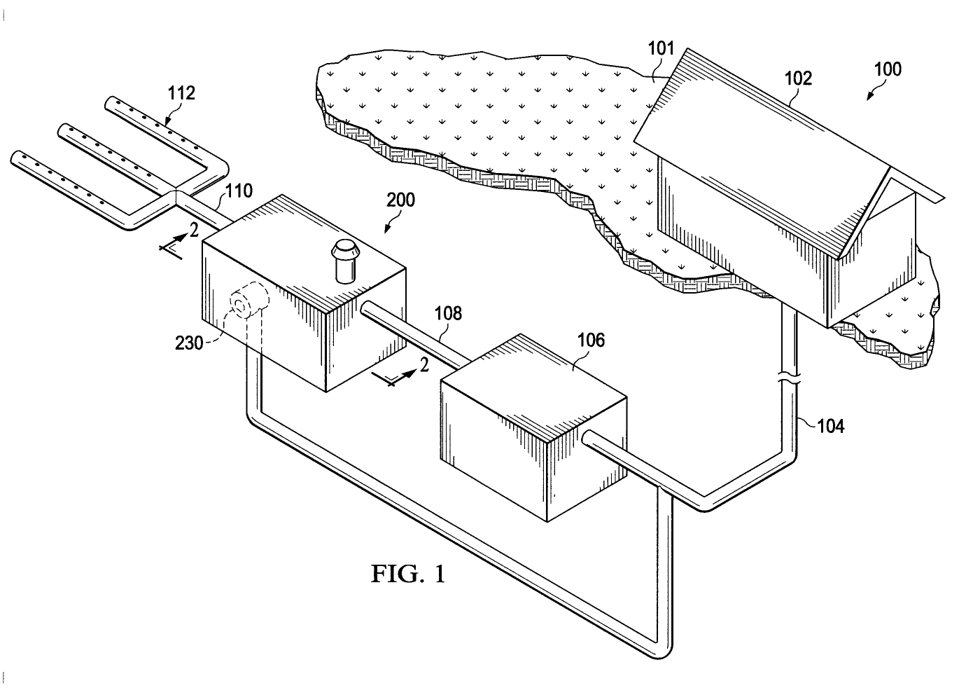

Referring now to FIG. 1, a perspective view of a septic system 100 is shown. The ground level 101 provides a demarcation point between a house 102 and a septic system below ground level 101. Leaving the house 102 is a sewage pipe or septic influent pipe 104. In some embodiments, the influent pipe 104 flows into a septic tank 106. As one skilled in the art will appreciate, a septic tank 106 may be of varying sizes and dimensions depending upon the structure and number of inhabitants being served by the septic tank 106.

In the present embodiment, a septic effluent pipe 108 also serves as an aeration unit influent pipe. In the present embodiment, the aeration influent pipe 108 feeds into a drip aeration unit 200. As will be described in greater detail below, in the present embodiment, the drip aeration unit 200 may be configured to deal with non-point discharges and overload conditions from the septic tank 106. Downstream of the aeration unit 200, is an aeration effluent pipe 110. This may connect to a lateral ground line network 112 for redistributing the digested sewage into the ground.

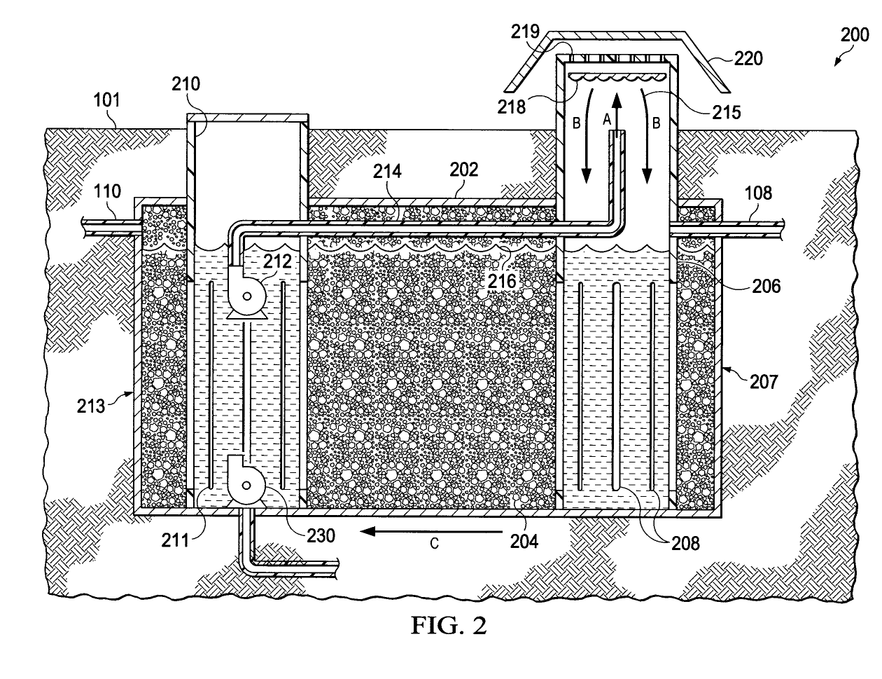

Referring now to FIG. 2, a side cutaway view of a drip aeration system according to aspects of the present disclosure is shown. The aeration unit 200 may generally comprise a tank 202 filled with a bacterial growth media 204. A drip aeration and mixing chamber 206 is provided and receives effluent from the septic effluent pipe 108 at an infludnet side 207 of the tank 200. In the present embodiment, a number of slots 208 or other perforations are provided in the drip aeration chamber 206 to allow the flow and exchange of liquids between the drip aeration chamber 208 and the tank 202 containing the growth media 204.

As fluids migrate or flow through the growth media 204 in the direction of arrow C, they may enter a recirculation chamber 210 of an effluent side 213 of the tank 202. Slots or perforations 211 may be provided in the recirculation chamber 210 to allow the influx of fluids from the growth media 204. A pump 212 may be provided within the recirculation chamber 210 connecting to a pipe 214 that routes back into the drip aeration chamber 206. The return pipe 214 may terminate in a spout 215 that is directed generally upward within the drip aeration chamber 206. It can be seen that when the drip aeration unit 200 is active, the pump 212 will generally remain below a fluid level 216. The spout 215 will generally extend above the fluid level 216 and discharge fluids in the direction shown by arrow A onto a diffuser plate 218. On or near below the diffuser plate 218, perforations or openings 219 will be provided to allow oxygenation of the diffused liquids. The diffused liquids will then fall back down from the diffuser plate 218 in the direction shown by arrows B down into the drip aeration chamber 206 for further cycling within the tank 202. In some embodiments, it may be desirable to keep additional fluids, such as rain, out of the system 200 and therefore any open ports may be provided with covers, such as the cover 220.

From the foregoing it will be appreciated that is some aspects, the present disclosure describes a one-day hydraulic residence time (HRT), drip aeration, media filtration, sedimentation and recirculation process that can be used for aerobic treatment of wastewater within a treatment tank after a septic tank 106 or other type of settling chamber. In the process, the treatment tank 200 is designed to hold the liquid volume of wastewater typically discharged from the septic tank 106 or settling chamber in about one day. The general flow of the treatment process is from septic tank/settling chamber 106 to the aeration unit 200 within which flow will first enter the aeration chamber 206, then flow through the filtration media 204, then flow into the sedimentation/recirculation chamber 210, then treated effluent is re-circulated back to the aeration chamber 206 or goes out as effluent from the treatment tank as a result of additional entry by influent from the septic tank or settling chamber.

The aerobic chamber 206 is generally on the influent side of the treatment tank 202. The filtration media is in the middle portion of the treatment tank between the aeration and sedimentation/recirculation chambers. The sedimentation/recirculation chamber is on the effluent side of the treatment tank. Treatment tank effluent is discharged via an outlet pipe when influent occurs. The top of the media 204 may be at or above the elevation of the top of the effluent pipe to prevent bypass of the media by overflow.

Within the process treatment tank 202, an aeration chamber 206 is used for drip aeration of re-circulated/treated wastewater and to receive incoming effluent from the septic tank 106 or settling chamber. Piping from the pump 212 in the upper portion of the sedimentation/recirculation chamber 210 enters the aeration chamber and directs the re-circulated/treated effluent flow upward inside the portion of the aeration chamber 206 that is above the liquid level 216 of the treatment tank 202. The upward flow of re-circulated/treated effluent (arrow A) strikes a diffuser plate 218 with knobby, dimpled or otherwise non-smooth surface on the upper interior of the aeration chamber 206 that allows for the creation of droplets (arrow B). The drip aeration chamber sides are slotted or have perforations to allow oxygen to flow in from the atmosphere. Slots or perforations 219 on the top or sides of the aeration chamber must be large enough for diffusion of oxygen into the chamber, but small enough or covered with an exterior shielding 220 that will prevent human contact with the effluent. The knobby or otherwise non-smooth surface of the diffuser plate 218 disperses the re-circulated/treated effluent flow over the upper interior of the aerobic chamber and gravity creates droplets. The droplets are further aerated by falling down the inside the aeration chamber and splashing on the surface 216 of the wastewater inside the chamber 206.

With continuous recirculation and aeration the aeration chamber 206 provides enough dissolved oxygen into the treatment tank 202 to maintain aerobic conditions necessary for the biodegradation of organic solids. The down flow of aerated drip mixes with the incoming wastewater from the septic tank/settling chamber 106 inside the aeration chamber 206 and starts the tank treatment process. The slots or perforations 208 on the sides of the aerobic chamber continue to the bottom of the chamber walls to allow for the dispersion of the aerated mixture to the filtration media 204.

One embodiment of the treatment process has a cleanable filter in the outlet baffle of the septic tank or settling chamber to decrease the potential for clogging of the treatment tank due to excess solids.

Within the process treatment tank 202, the filtration media 204 receives aerated drip mixed with incoming wastewater, traps wastewater solids to reduce the suspended solids content, provides surface area for microorganism growth to allow the biodegradation of trapped or suspended solids to reduce the biological oxygen demand of the wastewater and allows the media/microorganism treated effluent to flow on to the sedimentation/recirculation chamber. Filtration media may be pea gravel, shredded plastic, plastic netting or any other media or media combination that allows the previously described necessary media processes. Recycled materials may also be used. Primarily, the microorganism treatment in the media portion of the treatment tank 202 is aerobic biodegradation, but some anaerobic biodegradation may occur within larger solids or the accumulation of solids. Media 204 must be sized large enough or situated as to not enter recirculation pump 212 or pump line intakes.

Within the process treatment tank 202, the sedimentation/recirculation chamber 210 receives filtration media/microorganism treated wastewater, allows the heavier solids to accumulate at the bottom of the chamber due to the pull of the pump 212 in the top, upper portion of the chamber which also re-circulates treated wastewater from the effluent side of the treatment tank back to the aeration chamber 206 on the influent side of the treatment tank 202. The re-circulation rate must be sufficient to maintain aerobic conditions in the treatment tank by drip aeration. The re-circulation rate to maintain aerobic conditions will vary depending upon the organic loading, flow rate, volume treated, drip aeration efficiency and other factors. During research, a re-circulation rate that created turnover of the liquid volume of the entire process treatment tank within 19 minutes or less was necessary to maintain aerobic conditions.

One embodiment within the process treatment tank provides a pump 230 at the bottom of the sedimentation/recirculation chamber 210 to be used periodically to pump accumulated solids to the influent side of the septic tank/settling chamber 106. The recirculation of solids to the septic tank/settling chamber 106 must not be of a rate as to change the conditions in the process treatment tank 202 from aerobic to anaerobic due to the re-entry flow carrying excess organic solids back to the aeration unit 200. The recirculation of solids from the process treatment tank 202 to the influent side of the septic tank/settling chamber 106 should reduce settled and suspended solids in the treatment tank 202 and allow the settling, removal and further digestion of those solids by the septic tank/settling chamber 106.

Research has found that the removal of accumulated solids from the effluent end of the process treatment tank 202 is necessary to prevent the discharge of excess suspended solids in the effluent. Periodic pumping to remove the accumulation of solids in the effluent end of the process treatment tank 202 is necessary by internal or external situated pump 230. Recirculation of solids from the treatment tank to the septic tank/settling chamber may not be acceptable if exceeding 20% of the liquid volume of the treatment tank 202 per week. The rate of periodic pumping from the process treatment tank to the septic tank/settling chamber will vary depending upon organic loading, flow rate, volume treated and solids biodegradation by the filtration media/microorganism processes and other factors. A pump timer on the solids recirculation pump 230 set to suspend pumping when the visible solids content has decreased provides acceptable results, but may need periodic time adjustment. Pump timing that provides more frequent, but lower volume pump events for solids re-circulation will likely reduce the non-settling of solids in the septic tank/settling chamber 106 and thus reduce excess organic solids loading to the treatment tank 202. Filtration and/or the use of settling tubes at the septic tank/settling chamber outlet should also reduce solids flow to the treatment tank.

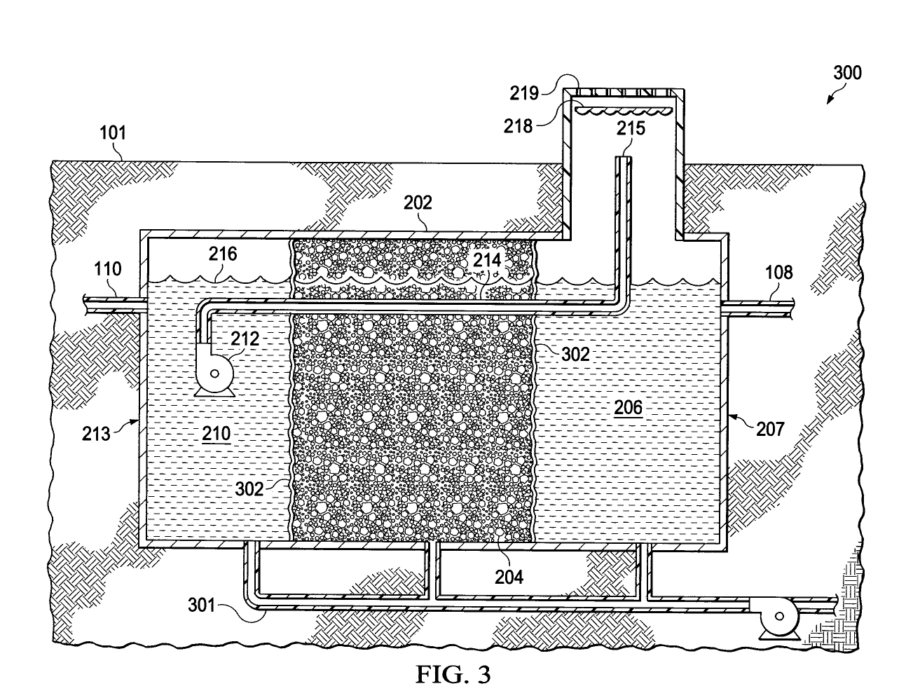

Referring now to FIG. 3, some embodiments may provide multiple pumps or pump intake lines 301 with strainers/perforations that accomplish the removal of excess solids that may accumulate in any area of the process treatment tank 202. A pump or pump intake line 301 at the bottom of the tank at the influent side 207, under the filtration media or at the bottom of the effluent side 213 may provide additional, beneficial removal of accumulated solids in the treatment tank to re-circulate the solids back to the influent side of the septic tank/settling chamber 106. Any pump or pump intake line will need strainers or perforations sized to prevent the uptake of filtration media.

A wastewater treatment process performance benefit from the re-circulation of solids from the effluent side 213 of the treatment tank 202 to the influent side of the septic tank/settling chamber 106 is better removal of total nitrogen from the treatment tank effluent. Aerobic conditions in the treatment tank 202 allow conversion of organic nitrogen to nitrate-nitrogen by nitrifying bacteria and the anaerobic conditions of the septic tank/settling chamber allow the conversion of the nitrate-nitrogen to nitrogen gas by denitrifying bacteria. The nitrogen gas escapes to the atmosphere and reduces total nitrogen in the effluent.

Other embodiments may use perforated walls or netting 302 inside the treatment tank 202 to keep filtration media away from the influent and effluent ends 207, 213 of the treatment tank. An example would be fastened perforated cross wall or netting dividers that would allow the flow of wastewater while restraining the media to the middle portion of the treatment tank. This would be allowable if a reduced volume of filtration media 204 were effective enough to maintain necessary media/microorganism functions. The volume saved by moving the filtration media inward could be used to increase influent end and effluent end liquid volume. The increased liquid volume in the influent end 207 could allow better mixing of aerated drip and incoming wastewater and provide greater space for solids accumulation at the bottom of the influent end 207. The increased liquid volume in the effluent end 213 could allow greater space for solids accumulation at the bottom of the effluent end and allow space for an effluent tube settler at the effluent outlet to decrease effluent suspended solids. Greater space for the accumulation of solids allows for the storage and then re-circulation of excess solids by pump or pump line to the septic tank/settling chamber. Research suggests that the management of solids is integral to better performance from the treatment process.

Other embodiments may use multiple aeration chambers 206 and/or multiple diffuser plates 218 on the influent end 207 and/or multiple sedimentation/recirculation chambers 210 on the effluent end 213 of the treatment tank 202 for large volume tanks or higher strength wastewater. Aeration and sedimentation/recirculation chambers must be situated to have maximum separation to avoid short-circuiting.

This disclosure was originally based on a 40 week doctoral research experiment conducted by the inventor that compared the pollution reduction capabilities of 3 types of one-day hydraulic residence time (HRT) sub-surface flow constructed wetlands (SCWs). The three types were non-aerated (W1), aerated (W2), and aerated with recycle (W3). The experiment used domestic sewage influent, three lab-scale septic tanks (S1, S2 and S3), and three lab-scale one-day hydraulic residence time subsurface flow constructed wetlands, SCWs (W1, W2 and W3). Data were collected on influent and effluent for BOD₅, TSS, ammonia-nitrogen, nitrate-nitrogen, total nitrogen, total phosphorus, pH and Escherichia coli. The data were analyzed with ANOVA for statistical significance at the alpha risk level of 0.05

The aerated SCW had significant pollutant reduction compared to the non-aerated SCW. Over the experimental period, the W2 aerated wetland outperformed the other wetlands in the % reduction of BOD₅, COD, E. coli, total phosphorus, total nitrogen and ammonia. The differences between the effluent mean mg/L levels of BOD₅, COD, total nitrogen, ammonia-nitrogen and mean MPN levels of E. coli between the W1 control un-aerated wetland and the W2 aerated wetland were statistically significant.

The National Sanitation Foundation's Standard 245 is commonly used for the certification of commercially available residential wastewater treatment units. The W2 wetland effluent performance was within the levels of all the NSF Standards for BOD₅, TSS, total nitrogen and pH, for the last 15 weeks of the experiment. The NSF Standards provide a basis for the comparison of the performance of the experimental wetlands to the expected performance of small commercial ATUs and filtration units for residential wastewater treatment. The W2 wetland compared favorably with all of the performance parameters of commercial treatment systems.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. An aerobic treatment unit comprising:
a tank with an influent end and an effluent end;
growth media between the influent and effluent ends;
an aeration chamber with a diffuser plate disposed near the influent end; and
at least one pump that moves surface liquids from the near the effluent end to the aeration chamber, where the fluids are aerated by the diffuser plate, back to an area in the tank near the influent end.

2. The aerobic treatment unit of claim 1, wherein the influent end receives influent from a septic tank.

3. The aerobic treatment unit of claim 1, further comprising a pump for removing solid materials from the near the effluent end.

4. The aerobic treatment unit of claim 1, wherein the surface liquid pump provides for substantially complete turnover of liquids within the tank about every 19 minutes,

5. The aerobic treatment unit of claim 1, wherein the at least one pump provides sufficient fluid aeration on the diffuser plate to maintain aerobic bacterial activity within the tank.

6. The aerobic treatment unit of claim 1, further comprising a settling chamber near the effluent end where solids collect on a bottom thereof and where the at least one pump is situated near a top thereof.

7. A method of treating septic tank effluent, comprising:
receiving effluent in an aeration chamber;
filtering the effluent out of the aeration chamber through bacterial growth media into a recirculation chamber; and
diffusing the effluent in the recirculation chamber for aeration and returning it to the aeration chamber.

8. The method of claim 7, further comprising pumping accumulated solids out of the recirculation chamber.

9. The method of claim 7, further comprising moving fluids into a drain field in response to receiving additional effluent in the aeration chamber.

10. The method of claim 7 wherein diffusing the effluent further comprises pumping the effluent against a diffuser plate within the aeration chamber.

11. The method of claim 7, further comprising providing a recycled material as the bacterial growth media.

12. A sewage aeration unit comprising:
a treatment tank containing aerobic bacterial growth media
an influent input on an influent side of the treatment tank connected to an output of a septic tank;
an effluent output on an effluent side of the treatment tank;
an aeration chamber near the influent side of the treatment tank containing an aeration diffuser plate; and
a recirculation chamber near the effluent side of the treatment tank containing a fluids pump that pumps fluids to the diffuser plate.

13. The sewage aeration unit of claim 12, wherein the aeration and recirculation chambers are defined by slotted chambers.

14. The sewage aeration unit of claim 12, wherein the aeration and recirculation chambers are defined by baffles retaining the growth media near a middle of the treatment tank.

15. The sewage aeration unit of claim 12, further comprising breather holes near the diffuser plate.

16. The sewage aeration unit of claim 12, further comprising a solids pump that removes solids from the treatment tank.
